(19) United States
(12) Patent Application Publication
(10) Pub. No.: US 2003/0181177 A1
(43) Pub. Date: Sep. 25, 2003

(54) High-frequency receiver apparatus

(76) Inventor: Yoshitaka Katagiri, Osaka (JP)

Correspondence Address: BIRCH STEWART KOLASCH & BIRCH, PO BOX 747, FALLS CHURCH, VA, 22040-0747, US

(21) Appl. No.: 10/391,770

(22) Filed: Mar. 20, 2003

(30) Foreign Application Priority Data
Mar. 20, 2002 (JP) 2002-78069

(51) Int. Cl. H04B 1/18

(52) U.S. Cl. 455/188.2; 455/130; 455/180.2

(57) ABSTRACT

A high-frequency receiver apparatus receives a plurality of high-frequency signals having different frequencies via an input terminal, then amplifies the high-frequency signals, and then selects from among the high-frequency signals a high-frequency signal having a desired frequency by means of an input tuning circuit. A trap circuit for eliminating unnecessary signals from the plurality of high-frequency signals received is provided between the input terminal and the input tuning circuit. When high-frequency signals spreading over the VHF and UHF bands are fed to the input terminal, those of which the reception is not desired are eliminated by the trap circuit.

### BACKGROUND OF THE INVENTION

1. Field of the Invention

The present invention relates to a high-frequency receiver apparatus for use in an electronic tuner for a television receiver.

2. Description of the Prior Art

In recent years, wired broadcasting systems that use dedicated cables, such as CATV (cable television) networks, have been becoming increasingly widespread for their capability of distributing television broadcast signals through multiple channels with sharper pictures and for other advantages. In such a wired broadcasting system, multiple channels are achieved by making the carrier center frequencies of individual television broadcast signals closer together and thus by making their frequency band widths narrower. As a result, as more and more television broadcast signals are distributed through multiple channels, a group of signals other than that of the intended reception channel may be received as interfering signals. When such interfering signals reach an amplifier or other circuit provided in an electronic tuner, the signal of the desired channel may be amplified with distortion, or the interfering signals themselves mix together to produce, through frequency conversion, an interfering signal in the frequency band of the desired reception channel. In either case, the reproduced television pictures suffer from reduced sharpness.

For example, suppose that, as shown in FIG. 1, the carrier center frequency of the television broadcast signal of the desired reception channel is 100 MHz (VHF), its frequency band width is ±3 MHz, and, through other channels, there are also distributed television broadcast signals having carrier center frequencies of 800 MHz (UHF), 700 MHz (UHF), 400 MHz (UHF), 302 MHz (VHF), 300 MHz (VHF), and 202 MHz (VHF), respectively. Moreover, assume that the 800 MHz signal mixes with the 700 MHz signal to produce a 100 MHz interfering signal, the 400 MHz signal mixes with the 302 MHz signal to produce a 98 MHz interfering signal, and the 300 MHz signal mixes with the 202 MHz signal to produce a 98 MHz interfering signal. Then, the 100 MHz component of the television broadcast signal (with a carrier center frequency of 100 MHz) of the desired reception channel suffers interference with the spurious 100 MHz signal produced by the aforementioned mixing of other signals. Likewise, the 98 MHz component of the television broadcast signal (with a carrier center frequency of 100 MHz) of the desired reception channel suffers interference with the two spurious 98 MHz signals produced by the aforementioned mixing of other signals. In FIG. 1, reference numeral 1 represents the frequency band of the desired reception signal, which has a carrier center frequency of 100 MHz (VHF) and a frequency band width of ±3 MHz, reference numeral 2 represents the 100 MHz interfering signal produced by the aforementioned mixing of other signals, and reference numeral 3 represents the 98 MHz interfering signals produced by the aforementioned mixing of other signals.

FIG. 2 is a block diagram showing the configuration of a conventional high-frequency receiver apparatus (electronic tuner). This high-frequency receiver apparatus is provided with an input terminal 21 to which an antenna or cable (not shown) is connected, an input preamplifier 22 for amplifying a high-frequency signal fed in via the input terminal 21, an input tuning circuit 23 for selecting a signal having the desired frequency from the high-frequency signal output from the input preamplifier 22, an RF amplifier 24 for amplifying the high-frequency signal selected by the input tuning circuit 23, an interstage tuning circuit 25 for selecting with higher accuracy the high-frequency signal output from the RF amplifier 24, a local oscillation circuit 26 for generating an oscillation signal for converting the high-frequency signal into an intermediate-frequency signal, and a mixing circuit 27 for mixing the high-frequency signal output from the interstage tuning circuit 25 with the oscillation signal output from the local oscillation circuit 26 to produce an intermediate-frequency signal.

Next, the operation of this conventional high-frequency receiver apparatus will be described. A high-frequency signal from a broadcast station, received by way of an antenna or cable connected to the input terminal 21, is fed in via the input terminal 21. The high-frequency signal is then fed to the input preamplifier 22 so as to be amplified, and the amplified high-frequency signal is then fed to the input tuning circuit 23. The input tuning circuit 23 permits the high-frequency signal of the desired broadcast station to be extracted through selection of a channel. Specifically, the input tuning circuit 23 selects and extracts the high-frequency signal of the desired broadcast station by tuning in to the frequency of the high-frequency signal of that broadcast station. The extracted high-frequency signal is then amplified by the RF amplifier 24, is then subjected to further tuning by the interstage tuning circuit 25 so as to be selected with higher accuracy, and is then fed to the mixing circuit 27. The mixing circuit 27 also receives, from the local oscillation circuit 26, an oscillation signal produced by the local oscillation circuit 26 so as to have a frequency higher, by an intermediate frequency, than that of the high-frequency signal from the interstage tuning circuit 25. Thus, the mixing circuit 27 mixes together the high-frequency signal from the interstage tuning circuit 25 with the oscillation signal from the local oscillation circuit 26 to produce an intermediate-frequency signal. The intermediate-frequency signal is then fed to produce an intermediate-frequency amplifier circuit (not shown).

Next, with reference to FIG. 3, how this conventional high-frequency receiver apparatus operates when the interfering signals described earlier appear in the frequency band of the high-frequency signal of the desired broadcast station. In FIG. 3, at (a) is shown the high-frequency signal 33, spreading over a VHF band 31 and a UHF band 32, fed in via the input terminal 21, at (b) is shown the high-frequency signal 34 obtained as a result of the high-frequency signal 33 being amplified by the input preamplifier 22, and at (c) is shown the high-frequency signal 35, lying in the VHF band 31, of the desired broadcast station selected as a result of the high-frequency signal 34 being fed to the input tuning circuit 23.

As described earlier with reference to FIG. 1, here, the high-frequency signal 35 of the desired broadcast station contains a group of interfering signals. How this happens is as follows. When the input preamplifier 22 is saturated, different frequency components of the high-frequency signal 33 fed to the input preamplifier 22 interact with one another to produce, as interfering signals, frequency components having frequencies equal to the sums of and differences between the original frequency components. Thus, the high-frequency signal 34 output from the input preamplifier 22 contains a group of interfering signals, and accordingly the high-frequency signal 35 of the desired broadcast station that has passed through the input tuning circuit 23 contains a group of interfering signals having frequencies that can pass through the input tuning circuit 23. This high-frequency signal 35 containing a group of interfering signals is further amplified by the RF amplifier 24, then passes through the interstage tuning circuit 25, and is then fed to the mixing circuit 27, where the interfering signals in the desired frequency band are, together with the desired high-frequency signal, converted into an intermediate-frequency signal. Thus, the intermediate-signal output from the mixing circuit 27 contains interfering signals.

How such interfering signals are produced is as follows. The input preamplifier 22 is required to amplify high-frequency signals spreading over both the VHF and UHF bands, and therefore its gain is set high beforehand. This makes the input preamplifier 22 easily saturable. The input preamplifier 22 can be prevented from being saturated by providing an attenuating circuit (for example, a PIN attenuator) for attenuating signals in a predetermined frequency band in a stage preceding the input preamplifier 22, as practiced in another conventionally known type of high-frequency receiver apparatus.

Incidentally, the wireless communications apparatus disclosed in Japanese Utility Model registered No. 3034543 is devised to make roughly equal the output levels of high-frequency signals in the VHF and UHF bands when they are transmitted. Thus, what is disclosed there is different from the processing of a received signal addressed in the present invention.

FIG. 4 is a block diagram of another type, mentioned above, of conventional high-frequency receiver apparatus. This high-frequency receiver apparatus is provided with an input terminal 21 to which an antenna or cable is connected, an attenuating circuit 28 for attenuating a high-frequency signal fed in via the input terminal 21, an input preamplifier 22 for amplifying the high-frequency signal attenuated by the attenuating circuit 28, an input tuning circuit 23 for selecting a signal having the desired frequency from the high-frequency signal output from the input preamplifier 22, an RF amplifier 24 for amplifying the high-frequency signal selected by the input tuning circuit 23, an interstage tuning circuit 25 for selecting with higher accuracy the high-frequency signal output from the RF amplifier 24, a local oscillation circuit 26 for generating an oscillation signal for converting the high-frequency signal into an intermediate-frequency signal, and a mixing circuit 27 for mixing the high-frequency signal output from the interstage tuning circuit 25 with the oscillation signal output from the local oscillation circuit 26 to produce an intermediate-frequency signal.

Next, the operation of this type of conventional high-frequency receiver apparatus will be described. A high-frequency signal from a broadcast station, received by way of an antenna or cable connected to the input terminal 21, is fed in via the input terminal 21. The high-frequency signal is then fed to the attenuating circuit 28 so as to be attenuated. The attenuated high-frequency signal is then fed to the input preamplifier 22 so as to be amplified, and the amplified high-frequency signal is then fed to the input tuning circuit 23. The input tuning circuit 23 permits the high-frequency signal of the desired broadcast station to be extracted through selection of a channel. Specifically, the input tuning circuit 23 selects and extracts the high-frequency signal of the desired broadcast station by tuning in to the frequency of the high-frequency signal of that broadcast station. The extracted high-frequency signal is then amplified by the RF amplifier 24, is then subjected to further tuning by the interstage tuning circuit 25 so as to be selected with higher accuracy, and is then fed to the mixing circuit 27. The mixing circuit 27 also receives, from the local oscillation circuit 26, an oscillation signal produced by the local oscillation circuit 26 so as to have a frequency higher, by an intermediate frequency, than that of the high-frequency signal from the interstage tuning circuit 25. Thus, the mixing circuit 27 mixes together the high-frequency signal from the interstage tuning circuit 25 with the oscillation signal from the local oscillation circuit 26 to produce an intermediate-frequency signal. The intermediate-frequency signal is then fed to produce an intermediate-frequency amplifier circuit (not shown).

As described above, in this type of conventional high-frequency receiver apparatus, the attenuating circuit 28 for attenuating the level of the input signal is provided in the stage preceding the input preamplifier 22, which, when saturated, produces distortion. This helps prevent the input preamplifier 22 from being saturated. However, the attenuating circuit 28 attenuates the level of the input signal in all frequency bands. Thus, the level of the high-frequency signal of the broadcast station of which the reception is desired is also attenuated. This degrades noise characteristics, which indicate the noise figures at specific frequencies, and thus leads to less accurate reception of the high-frequency signal of which the reception is desired.

### SUMMARY OF THE INVENTION

An object of the present invention is to provide a high-frequency receiver apparatus that can suppress as much as possible signals outside the desired reception frequency band and thereby narrow as much as possible the frequency bands in which interfering signals are allowed in.

To achieve the above object, according to the present invention, in a high-frequency receiver apparatus that receives a plurality of high-frequency signals having different frequencies via an input terminal, that then amplifies the high-frequency signals, and that then selects from among the high-frequency signals a high-frequency signal having a desired frequency by means of an input tuning circuit, a trap circuit for eliminating unnecessary signals from the plurality of high-frequency signals received is provided between the input terminal and the input tuning circuit.

In this circuit configuration, when, for example, high-frequency signals spreading over the VHF and UHF bands are fed to the input terminal, and the desired reception signal is a high-frequency signal in the VHF band, the trap circuit acts to suppress as much as possible the high-frequency signals in the UHF band. This reduces interfering signals resulting from signals unnecessarily allowed in, and thus enhances the selection accuracy of the input tuning circuit. That is, the trap circuit suppresses as much as possible signals outside the desired reception frequency band and thereby narrows the frequency bands in which interfering signals are allowed in. This makes it possible to obtain the desired high-frequency signal with reduced interfering signals and with higher accuracy.

Alternatively, according to the present invention, in a high-frequency receiver apparatus that receives a plurality of high-frequency signals having different frequencies via an input terminal, that then amplifies the high-frequency signals, and that then selects from among the high-frequency signals a high-frequency signal having a desired frequency by means of an input tuning circuit, a trap circuit for eliminating unnecessary signals from the plurality of high-frequency signals received is provided between the input terminal and the input tuning circuit, and a buffer amplifier for correcting the input impedance mismatch ascribable to the trap circuit is provided between the input terminal and the trap circuit.

In this circuit configuration, when, for example, high-frequency signals spreading over the VHF and UHF bands are fed to the input terminal, and the desired reception signal is a high-frequency signal in the VHF band, the trap circuit acts to suppress as much as possible the high-frequency signals in the UHF band. This reduces interfering signals resulting from signals unnecessarily allowed in, and thus enhances the selection accuracy of the input tuning circuit. That is, the trap circuit suppresses as much as possible signals outside the desired reception frequency band and thereby narrows the frequency bands in which interfering signals are allowed in. This makes it possible to obtain the desired high-frequency signal with reduced interfering signals and with higher accuracy. The provision of the trap circuit may degrade the input impedance as seen from the input terminal. This input impedance mismatch can be corrected by the provision of the buffer amplifier. This makes it possible to efficiently receive the high-frequency signal from the antenna or cable via the input terminal and thereby obtain the high-frequency signal with less distortion.

In the above-described high-frequency receiver apparatuses according to the present invention, the trap circuit may be composed of a first trap having the circuit thereof so configured as to pass high-frequency signals in a first frequency band and a second trap having the circuit thereof so configured as to pass high-frequency signals in a second frequency band. When a high-frequency signal in the first frequency band (VHF band) is received, the circuit of the second trap (trap for UHF) is formed, so that high-frequency signals in the second frequency band (UHF band) are attenuated; when a high-frequency signal in the second frequency band (UHF band) is received, the circuit of the first trap (trap for VHF) is formed, so that high-frequency signals in the first frequency band (VHF band) are attenuated. Thus, the provision of the trap circuit helps reduce interfering signals that interfere with the desired reception signal.

In the above-described high-frequency receiver apparatuses according to the present invention, the trap circuit may be composed of a first trap having the circuit thereof so configured as to pass high-frequency signals in a first frequency band, a second trap having the circuit thereof so configured as to pass high-frequency signals in a second frequency band, and trap switching means for performing switching in such a way as to form the circuit of the second trap when a high-frequency signal in the first frequency band is received and form the circuit of the first trap when a high-frequency signal in the second frequency band is received. When a high-frequency signal in the first frequency band (VHF band) is received, the trap switching means performs switching so as to form the circuit of the second trap (trap for UHF), so that high-frequency signals in the second frequency band (UHF band) are attenuated; when a high-frequency signal in the second frequency band (UHF band) is received, the trap switching means performs switching so as to form the circuit of the first trap (trap for VHF), so that high-frequency signals in the first frequency band (VHF band) are attenuated. Thus, the provision of the trap circuit helps reduce interfering signals that interfere with the desired reception signal.

In the above-described high-frequency receiver apparatuses according to the present invention, the trap switching means may perform the switching based on a control voltage that is switched between different levels according to whether to receive a high-frequency signal in the first or second frequency band. This permits the switching between the first and second traps to be realized with a simple circuit configuration.

In the above-described high-frequency receiver apparatuses according to the present invention, the trap switching means may be a switching diode that is turned on and off by the control voltage. This permits the switching between the first and second traps to be performed rapidly and easily.

### BRIEF DESCRIPTION OF THE DRAWINGS

This and other objects and features of the present invention will become clear from the following description, taken in conjunction with the preferred embodiments with reference to the accompanying drawings in which:

FIG. 1 is a frequency band diagram of a high-frequency signal illustrating how an interfering signal is produced in a conventional high-frequency receiver apparatus;

FIG. 2 is a block diagram showing the configuration of a conventional high-frequency receiver apparatus;

FIG. 3 is a diagram showing the flow of the high-frequency signal dealt with in the high-frequency receiver apparatus shown in FIG. 2;

FIG. 4 is a block diagram showing the configuration of another conventional high-frequency receiver apparatus;

FIG. 5 is a block diagram showing the configuration of a high-frequency receiver apparatus embodying the invention;

FIG. 6 is a circuit diagram of the trap circuit shown in FIG. 5;

FIG. 7 is a circuit diagram illustrating how a circuit of a UHF trap is formed in the trap circuit shown in FIG. 6;

FIG. 8 is a circuit diagram illustrating how a circuit of a VHF trap is formed in the trap circuit shown in FIG. 6;

FIG. 9 is a diagram showing the flow of the high-frequency signal dealt with in the high-frequency receiver apparatus shown in FIG. 5; and

FIG. 10 is a block diagram showing the configuration of another high-frequency receiver apparatus embodying the invention.

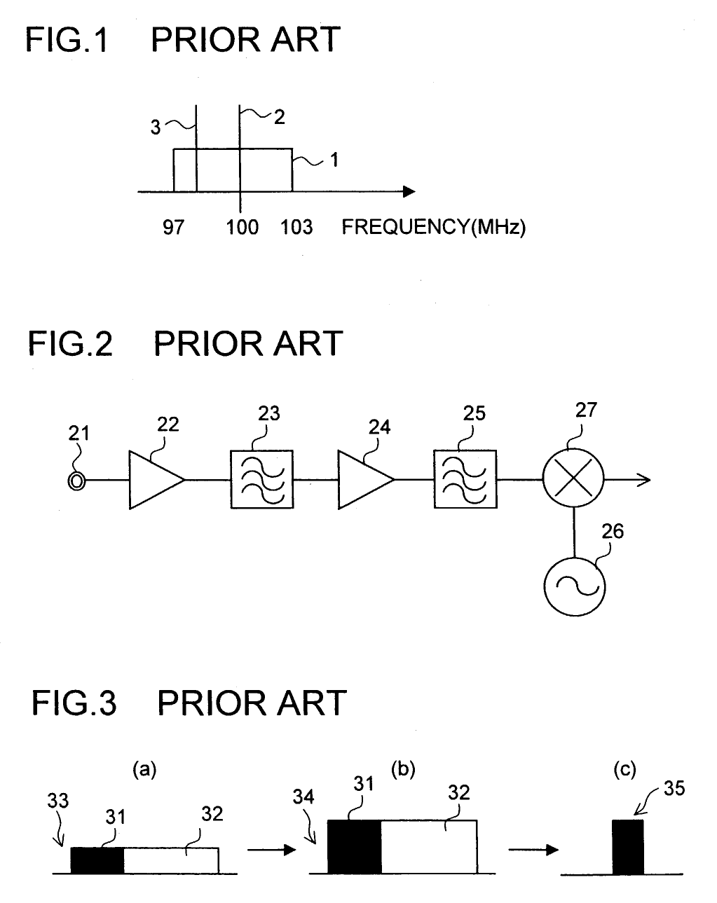

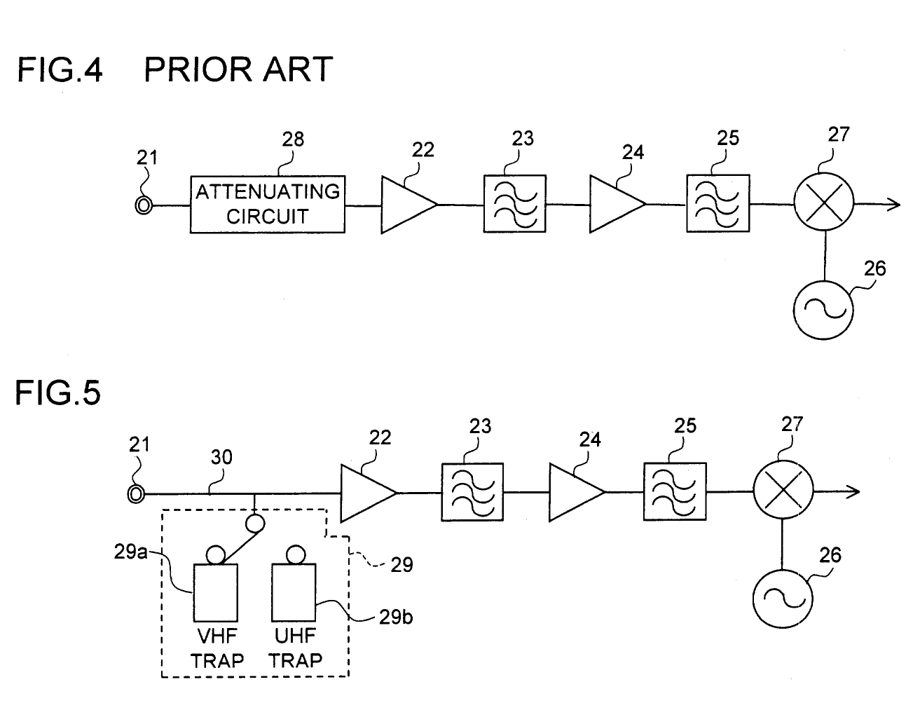

### DESCRIPTION OF THE PREFERRED EMBODIMENTS

Hereinafter, embodiments of the present invention will be described with reference to the drawings.

FIG. 5 is a block diagram showing the configuration of a high-frequency receiver apparatus embodying the invention. This high-frequency receiver apparatus is provided with an input terminal 21 to which an antenna or cable is connected, a band-switchable trap circuit 29 for selectively attenuating high-frequency signals in the VHF band or high-frequency signals in the UHF band among those constituting the high-frequency signal fed in via the input terminal 21, an input preamplifier 22 for amplifying the high-frequency signals other than those attenuated by the trap circuit 29, an input tuning circuit 23 for selecting a signal having the desired frequency from the high-frequency signals output from the input preamplifier 22, an RF amplifier 24 for amplifying the high-frequency signal selected by the input tuning circuit 23, an interstage tuning circuit 25 for selecting with higher accuracy the high-frequency signal output from the RF amplifier 24, a local oscillation circuit 26 for generating an oscillation signal for converting the high-frequency signal into an intermediate-frequency signal, and a mixing circuit 27 for mixing the high-frequency signal output from the interstage tuning circuit 25 with the oscillation signal output from the local oscillation circuit 26 to produce an intermediate-frequency signal.

The trap circuit 29, which characterizes this embodiment, forms a VHF trap 29a to eliminate high-frequency signals in the VHF band when a high-frequency signal in the UHF band is received, and forms a UHF trap 29b to eliminate high-frequency signals in the UHF band when a high-frequency signal in the VHF band is received.

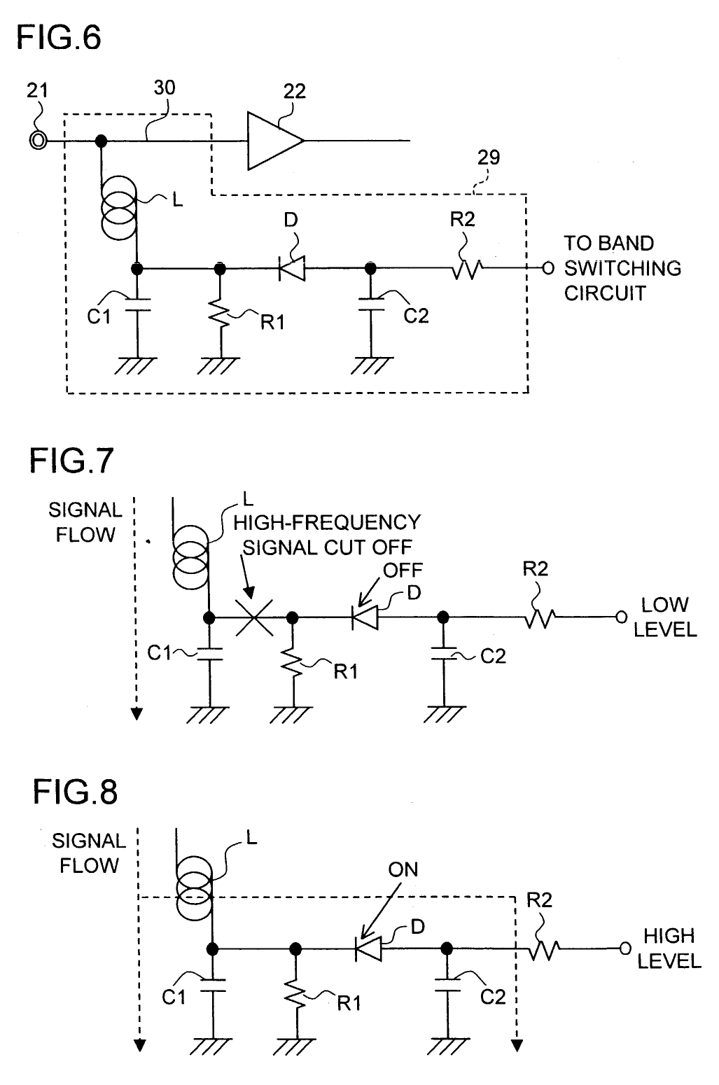

FIG. 6 is a circuit diagram of the trap circuit 29. As shown in FIG. 6, the trap circuit 29 is provided with a trapping coil L, trapping capacitors C1 and C2, a switching diode D, and resistors R1 and R2 for biasing the switching diode D. One end of the coil L is connected to a signal line 30 connecting between the input terminal 21 and the input preamplifier 22, and the other end of the coil L is connected to one end of the capacitor C1, to one end of the resistor R1, and to the cathode of the switching diode D. The other end of the capacitor C1 and the other end of the resistor R1 are grounded. The anode of the switching diode D is connected to one end of the capacitor C2 and to one end of the resistor R2. The other end of the capacitor C2 is grounded. The other end of the resistor R2 is connected to the output terminal of a band switching circuit that produces a band switching signal with which the switching between the VHF and UHF bands is achieved. For example, used as the band switching circuit is the band switching power supply circuit of an electronic tuner, and used as the control voltage for the switching diode D is the VHF switching supply voltage used in the band switching circuit (i.e., the supply voltage generated when the circuit switches to VHF).

Now, how the trap circuit 29 configured as described above operates will be described with reference to FIGS. 7 and 8. FIG. 7 is a circuit diagram illustrating the flow of signals when, for the reception of a high-frequency signal in the VHF band, a circuit of a UHF trap is formed to eliminate high-frequency signals in the UHF band. When a high-frequency signal in the VHF band is received, the band switching circuit (not shown) outputs a low-level signal, which is fed through the resistor R2 to the anode of the switching diode D. This turns the switching diode D off, forming a trap circuit (tuning circuit) composed only of the coil L and the capacitor C1. The inductance of the coil L and the capacitance of the capacitor C1 are so set that high-frequency signals in the UHF band more readily pass to ground. Thus, when a high-frequency signal in the VHF band is received, the trap circuit composed only of the coil L and the capacitor C1 reduces high-frequency signals in the UHF band that pass through the signal line 30, and thereby narrows the frequency bands in which the input preamplifier 22 may be saturated. In this way, in the high-frequency receiver apparatus of this embodiment, it is possible to narrow the frequency bands in which interfering signals are allowed in, and thereby obtain the high-frequency signal of the desired broadcast station with high accuracy when it is in the VHF band.

FIG. 8 is a circuit diagram illustrating the flow of signals when, for the reception of a high-frequency signal in the UHF band, a circuit of a VHF trap is formed to eliminate high-frequency signals in the VHF band. When a high-frequency signal in the UHF band is received, the band switching circuit (not shown) outputs a high-level signal, which is fed through the resistor R2 to the anode of the switching diode D. This turns the switching diode D on, forming a trap circuit (tuning circuit) composed of the coil L and the capacitors C1 and C2. The inductance of the coil L and the capacitance of the capacitor C1 are, as described above, so set that high-frequency signals in the UHF band more readily pass to ground, and are in addition so set that, when the capacitor C2 is connected in parallel with the capacitor C1, high-frequency signals in the VHF band more readily pass to ground. Thus, when a high-frequency signal in the UHF band is received, the trap circuit composed of the coil L and the capacitors C1 and C2 reduces high-frequency signals in the VHF band that pass through the signal line 30, and thereby narrows the frequency bands in which the input preamplifier 22 may be saturated. In this way, in the high-frequency receiver apparatus of this embodiment, it is possible to narrow the frequency bands in which interfering signals are allowed in, and thereby obtain the high-frequency signal of the desired broadcast station with high accuracy when it is in the UHF band.

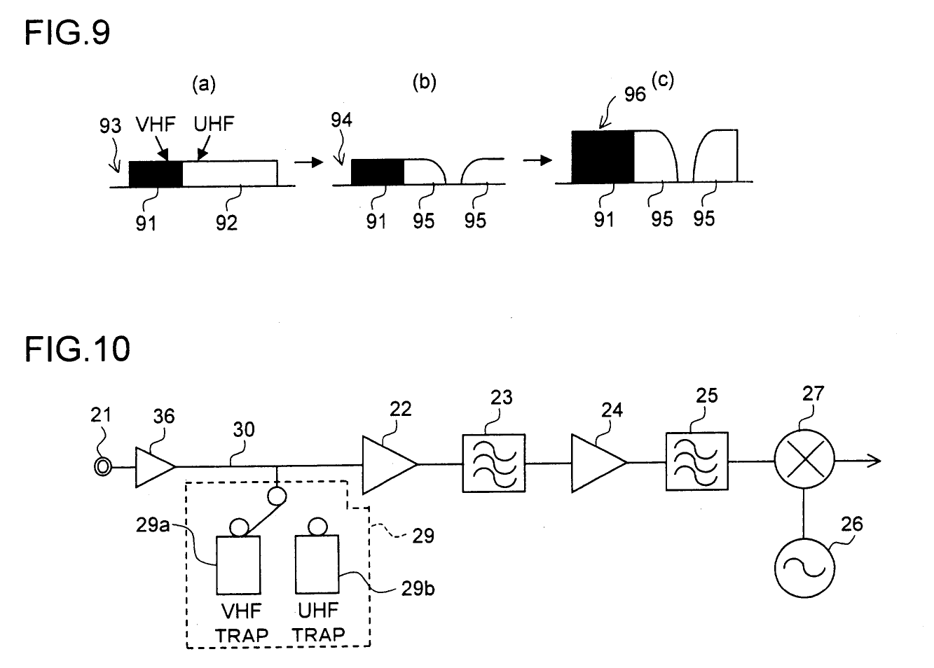

FIG. 9 is a diagram showing the frequency band of the signal dealt with, illustrating the effect of the trap circuit 29. Here, a description will be given only of a case where a high-frequency signal in the VHF band is received. In FIG. 9, at (a) is shown the high-frequency signal 93, spreading over the VHF band 91 and the UHF band 92, fed in via the input terminal 21, at (b) is shown the high-frequency signal 94 spreading over the VHF band 91 and the UHF band 95 after passing through the UHF trap 29b (see FIG. 5), and at (c) is shown the high-frequency signal 96 obtained as a result of the high-frequency signal 94 being amplified by the input preamplifier 22. As shown at (c) in FIG. 9, a predetermined part of the UHF band 95 is cut off, narrowing the frequency bands in which the input preamplifier 22 may be saturated.

Next, the operation of the high-frequency receiver apparatus shown in FIG. 5 as a whole will be described. First, a description will be given of a case where a desired high-frequency signal in the VHF band is extracted. As described above, when a high-frequency signal in the VHF band is received, the trap circuit 29 receives a low-level signal from the band switching circuit, and forms the circuit of the UHF trap 29b. Of the high-frequency signals from broadcast stations that are received by way of an antenna or cable and then fed in via the input terminal 21 connected thereto, those in the UHF band have predetermined frequency components thereof (i.e., the frequency components corresponding to the tuning characteristic of the trap) attenuated as a result of their passing through the UHF trap 29b. Thus, the input preamplifier 22 receives and amplifies high-frequency signals in the VHF band, which are intact, and high-frequency signals in the UHF band, which are attenuated. Here, predetermined frequency components of the high-frequency signals in the UHF band that are fed to the input preamplifier 22 are cut off, and this narrows the frequency bands in which the input preamplifier 22 may be saturated and thereby reduces the generation of interfering signals.

The amplified high-frequency signals are then fed to the input tuning circuit 23. The input tuning circuit 23 permits the high-frequency signal, in the VHF band, of the desired broadcast station to be extracted through selection of a channel. Specifically, the input tuning circuit 23 selects and extracts the high-frequency signal, in the VHF band, of the desired broadcast station by tuning in to the frequency of the high-frequency signal of that broadcast station. The extracted high-frequency signal in the VHF band is then amplified by the RF amplifier 24, is then subjected to further tuning by the interstage tuning circuit 25 so as to be selected with higher accuracy, and is then fed to the mixing circuit 27. The mixing circuit 27 also receives, from the local oscillation circuit 26, an oscillation signal produced by the local oscillation circuit 26 so as to have a frequency higher, by an intermediate frequency, than that of the high-frequency signal from the interstage tuning circuit 25. Thus, the mixing circuit 27 mixes together the high-frequency signal from the interstage tuning circuit 25 with the oscillation signal from the local oscillation circuit 26 to produce an intermediate-frequency signal. The intermediate-frequency signal is then fed to produce an intermediate-frequency amplifier circuit (not shown).

In this way, when a high-frequency signal in the VHF band is received, the trap circuit 29 provided between the input terminal 21 and the input preamplifier 22 attenuates high-frequency signals in the UHF band that pass through the signal line 30. This reduces interfering signals generated in the input preamplifier 22 and thereby permits reception of the desired high-frequency signal in the VHF band with higher accuracy.

Next, a description will be given of a case where a desired high-frequency signal in the UHF band is extracted. As described above, when a high-frequency signal in the UHF band is received, the trap circuit 29 receives a high-level signal from the band switching circuit, and forms the circuit of the VHF trap 29a. Of the high-frequency signals from broadcast stations that are received by way of an antenna or cable and then fed in via the input terminal 21 connected thereto, those in the VHF band are attenuated as a result of their passing through the VHF trap 29a. Thus, the input preamplifier 22 receives and amplifies high-frequency signals in the UHF band, which are intact, and high-frequency signals in the VHF band, which are attenuated. Here, predetermined frequency components of the high-frequency signals in the VHF band that are fed to the input preamplifier 22 are cut off, and this narrows the frequency bands in which the input preamplifier 22 may be saturated and thereby reduces the generation of interfering signals.

The amplified high-frequency signals are then fed to the input tuning circuit 23. The input tuning circuit 23 permits the high-frequency signal, in the UHF band, of the desired broadcast station to be extracted through selection of a channel. Specifically, the input tuning circuit 23 selects and extracts the high-frequency signal, in the UHF band, of the desired broadcast station by tuning in to the frequency of the high-frequency signal of that broadcast station. The extracted high-frequency signal in the UHF band is then amplified by the RF amplifier 24, is then subjected to further tuning by the interstage tuning circuit 25 so as to be selected with higher accuracy, and is then fed to the mixing circuit 27. The mixing circuit 27 also receives, from the local oscillation circuit 26, an oscillation signal produced by the local oscillation circuit 26 so as to have a frequency higher, by an intermediate frequency, than that of the high-frequency signal from the interstage tuning circuit 25. Thus, the mixing circuit 27 mixes together the high-frequency signal from the interstage tuning circuit 25 with the oscillation signal from the local oscillation circuit 26 to produce an intermediate-frequency signal. The intermediate-frequency signal is then fed to produce an intermediate-frequency amplifier circuit (not shown).

In this way, when a high-frequency signal in the UHF band is received, the trap circuit 29 provided between the input terminal 21 and the input preamplifier 22 attenuates high-frequency signals in the VHF band that pass through the signal line 30. This reduces interfering signals generated in the input preamplifier 22 and thereby permits reception of the desired high-frequency signal in the VHF band with higher accuracy.

FIG. 10 is a block diagram showing the configuration of another high-frequency receiver apparatus embodying the invention. This high-frequency receiver apparatus is provided with an input terminal 21 to which an antenna or cable is connected, a buffer amplifier 36 connected to the input terminal 21, a band-switchable trap circuit 29 for selectively attenuating high-frequency signals in the VHF band or high-frequency signals in the UHF band among those constituting the high-frequency signal output from the buffer amplifier 36, an input preamplifier 22 for amplifying the high-frequency signals other than those attenuated by the trap circuit 29, an input tuning circuit 23 for selecting a signal having the desired frequency from the high-frequency signals output from the input preamplifier 22, an RF amplifier 24 for amplifying the high-frequency signal selected by the input tuning circuit 23, an interstage tuning circuit 25 for selecting with higher accuracy the high-frequency signal output from the RF amplifier 24, a local oscillation circuit 26 for generating an oscillation signal for converting the high-frequency signal into an intermediate-frequency signal, and a mixing circuit 27 for mixing the high-frequency signal output from the interstage tuning circuit 25 with the oscillation signal output from the local oscillation circuit 26 to produce an intermediate-frequency signal.

The additional feature of this high-frequency receiver apparatus is that, to prevent an input impedance mismatch as seen from the input terminal 21 that may result from the provision of the trap circuit 29 in the stage preceding the input preamplifier 22, the buffer amplifier 36, having an appropriate input impedance, is provided between the input terminal 21 and the trap circuit 29. This permits the high-frequency signal fed in via the input terminal 21 to be fed without degradation to the signal line 30, and thus helps prevent the disadvantage resulting from the provision of the trap circuit 29.

Next, the operation of the high-frequency receiver apparatus shown in FIG. 10 as a whole will be described. First, a description will be given of a case where a desired high-frequency signal in the VHF band is extracted. As described earlier, when a high-frequency signal in the VHF band is received, the trap circuit 29, more specifically the switching diode D (see FIG. 7), receives a low-level signal from the band switching circuit, and forms the circuit of the UHF trap 29b. The high-frequency signals from broadcast stations that are received by way of an antenna or cable and then fed in via the input terminal 21 connected thereto are subjected to impedance matching by the buffer amplifier 36, and are then fed to the signal line 30. Of these high-frequency signals, those in the UHF band have predetermined frequency components thereof (i.e., the frequency components corresponding to the tuning characteristic of the trap) attenuated as a result of their passing through the UH trap 29b. Thus, the input preamplifier 22 receives and amplifies high-frequency signals in the VHF band, which are intact, and high-frequency signals in the UHF band, which are attenuated. Here, predetermined frequency components of the high-frequency signals in the UHF band that are fed to the input preamplifier 22 are cut off, and this narrows the frequency bands in which the input preamplifier 22 may be saturated and thereby reduces the generation of interfering signals.

The amplified high-frequency signals are then fed to the input tuning circuit 23. The input tuning circuit 23 permits the high-frequency signal, in the VHF band, of the desired broadcast station to be extracted through selection of a channel. Specifically, the input tuning circuit 23 selects and extracts the high-frequency signal, in the VHF band, of the desired broadcast station by tuning in to the frequency of the high-frequency signal of that broadcast station. The extracted high-frequency signal in the VHF band is then amplified by the RF amplifier 24, is then subjected to further tuning by the interstage tuning circuit 25 so as to be selected with higher accuracy, and is then fed to the mixing circuit 27. The mixing circuit 27 also receives, from the local oscillation circuit 26, an oscillation signal produced by the local oscillation circuit 26 so as to have a frequency higher, by an intermediate frequency, than that of the high-frequency signal from the interstage tuning circuit 25. Thus, the mixing circuit 27 mixes together the high-frequency signal from the interstage tuning circuit 25 with the oscillation signal from the local oscillation circuit 26 to produce an intermediate-frequency signal. The intermediate-frequency signal is then fed to produce an intermediate-frequency amplifier circuit (not shown).

In this way, when a high-frequency signal in the VHF band is received, the trap circuit 29 provided between the input terminal 21 and the input preamplifier 22 attenuates high-frequency signals in the UHF band that pass through the input terminal 21. This reduces interfering signals generated in the input preamplifier 22 and thereby permits reception of the desired high-frequency signal in the VHF band with higher accuracy.

Next, a description will be given of a case where a desired high-frequency signal in the UHF band is extracted. As described earlier, when a high-frequency signal in the UHF band is received, the trap circuit 29 receives a high-level signal from the band switching circuit, and forms the circuit of the VHF trap 29a. The high-frequency signals from broadcast stations that are received by way of an antenna or cable and then fed in via the input terminal 21 connected thereto are subjected to impedance matching by the buffer amplifier 36, and then, of these high-frequency signals, those in the VHF band are attenuated as a result of their passing through the VHF trap 29a. Thus, the input preamplifier 22 receives and amplifies high-frequency signals in the UHF band, which are intact, and high-frequency signals in the VHF band, which are attenuated. Here, predetermined frequency components of the high-frequency signals in the VHF band that are fed to the input preamplifier 22 are cut off, and this narrows the frequency bands in which the input preamplifier 22 may be saturated and thereby reduces the generation of interfering signals.

The amplified high-frequency signals are then fed to the input tuning circuit 23. The input tuning circuit 23 permits the high-frequency signal, in the UHF band, of the desired broadcast station to be extracted through selection of a channel. Specifically, the input tuning circuit 23 selects and extracts the high-frequency signal, in the UHF band, of the desired broadcast station by tuning in to the frequency of the high-frequency signal of that broadcast station. The extracted high-frequency signal in the UHF band is then amplified by the RF amplifier 24, is then subjected to further tuning by the interstage tuning circuit 25 so as to be selected with higher accuracy, and is then fed to the mixing circuit 27. The mixing circuit 27 also receives, from the local oscillation circuit 26, an oscillation signal produced by the local oscillation circuit 26 so as to have a frequency higher, by an intermediate frequency, than that of the high-frequency signal from the interstage tuning circuit 25. Thus, the mixing circuit 27 mixes together the high-frequency signal from the interstage tuning circuit 25 with the oscillation signal from the local oscillation circuit 26 to produce an intermediate-frequency signal. The intermediate-frequency signal is then fed to produce an intermediate-frequency amplifier circuit (not shown).

In this way, when a high-frequency signal in the UHF band is received, the trap circuit 29 provided between the input terminal 21 and the input preamplifier 22 attenuates high-frequency signals in the VHF band that pass through the input terminal 21. This reduces interfering signals generated in the input preamplifier 22 and thereby permits reception of the desired high-frequency signal in the UHF band with higher accuracy. The provision of the trap circuit may degrade the input impedance as seen from the input terminal 21. This input impedance mismatch can be corrected by the provision of the buffer amplifier 36. This makes it possible to efficiently receive the high-frequency signal from the antenna or cable via the input terminal 21 and thereby obtain the high-frequency signal with less distortion.

As described above, according to the present invention, in a high-frequency receiver apparatus that receives a plurality of high-frequency signals having different frequencies via an input terminal, that then amplifies the high-frequency signals, and that then selects from among the high-frequency signals a high-frequency signal having a desired frequency by means of an input tuning circuit, a trap circuit for eliminating unnecessary signals from the plurality of high-frequency signals received is provided between the input terminal and the input tuning circuit. In this circuit configuration, when, for example, high-frequency signals spreading over the VHF and UHF bands are fed to the input terminal, and the desired reception signal is a high-frequency signal in the VHF band, the trap circuit acts to suppress as much as possible the high-frequency signals in the UHF band. This reduces interfering signals resulting from signals unnecessarily allowed in, and thus enhances the selection accuracy of the input tuning circuit. That is, the trap circuit suppresses as much as possible signals outside the desired reception frequency band and thereby narrows the frequency bands in which interfering signals are allowed in. This makes it possible to obtain the desired high-frequency signal with reduced interfering signals and with higher accuracy.

Alternatively, according to the present invention, in a high-frequency receiver apparatus that receives a plurality of high-frequency signals having different frequencies via an input terminal, that then amplifies the high-frequency signals, and that then selects from among the high-frequency signals a high-frequency signal having a desired frequency by means of an input tuning circuit, a trap circuit for eliminating unnecessary signals from the plurality of high-frequency signals received is provided between the input terminal and the input tuning circuit, and a buffer amplifier for correcting the input impedance mismatch ascribable to the trap circuit is provided between the input terminal and the trap circuit. In this circuit configuration, when, for example, high-frequency signals spreading over the VHF and UHF bands are fed to the input terminal, and the desired reception signal is a high-frequency signal in the VHF band, the trap circuit acts to suppress as much as possible the high-frequency signals in the UHF band. This reduces interfering signals resulting from signals unnecessarily allowed in, and thus enhances the selection accuracy of the input tuning circuit. That is, the trap circuit suppresses as much as possible signals outside the desired reception frequency band and thereby narrows the frequency bands in which interfering signals are allowed in. This makes it possible to obtain the desired high-frequency signal with reduced interfering signals and with higher accuracy. The provision of the trap circuit may degrade the input impedance as seen from the input terminal. This input impedance mismatch can be corrected by the provision of the buffer amplifier. This makes it possible to efficiently receive the high-frequency signal from the antenna or cable via the input terminal and thereby obtain the high-frequency signal with less distortion.

What is claimed is:

1. A high-frequency receiver apparatus that receives a plurality of high-frequency signals having different frequencies via an input terminal, that then amplifies the high-frequency signals, and that then selects from among the high-frequency signals a high-frequency signal having a desired frequency by means of an input tuning circuit,
wherein a trap circuit for eliminating unnecessary signals from the plurality of high-frequency signals received is provided between the input terminal and the input tuning circuit.

2. A high-frequency receiver apparatus as claimed in claim 1,
wherein the trap circuit comprises a first trap having a circuit thereof so configured as to pass high-frequency signals in a first frequency band and a second trap having a circuit thereof so configured as to pass high-frequency signals in a second frequency band.

3. A high-frequency receiver apparatus as claimed in claim 1,
wherein the trap circuit comprises a first trap having a circuit thereof so configured as to pass high-frequency signals in a first frequency band, a second trap having a circuit thereof so configured as to pass high-frequency signals in a second frequency band, and trap switching means for performing switching in such a way as to form the circuit of the second trap when a high-frequency signal in the first frequency band is received and form the circuit of the first trap when a high-frequency signal in the second frequency band is received.

4. A high-frequency receiver apparatus as claimed in claim 3,
wherein the trap switching means performs the switching based on a control voltage that is switched between different levels according to whether to receive a high-frequency signal in the first or second frequency band.

5. A high-frequency receiver apparatus as claimed in claim 4,
wherein the trap switching means is a switching diode that is turned on and off by the control voltage.

6. A high-frequency receiver apparatus that receives a plurality of high-frequency signals having different frequencies via an input terminal, that then amplifies the high-frequency signals, and that then selects from among the high-frequency signals a high-frequency signal having a desired frequency by means of an input tuning circuit,
wherein a trap circuit for eliminating unnecessary signals from the plurality of high-frequency signals received is provided between the input terminal and the input tuning circuit, and a buffer amplifier for correcting an input impedance mismatch ascribable to the trap circuit is provided between the input terminal and the trap circuit.

7. A high-frequency receiver apparatus as claimed in claim 6,
wherein the trap circuit comprises a first trap having a circuit thereof so configured as to pass high-frequency signals in a first frequency band and a second trap having a circuit thereof so configured as to pass high-frequency signals in a second frequency band.

8. A high-frequency receiver apparatus as claimed in claim 6,
wherein the trap circuit comprises a first trap having a circuit thereof so configured as to pass high-frequency signals in a first frequency band, a second trap having a circuit thereof so configured as to pass high-frequency signals in a second frequency band, and trap switching means for performing switching in such a way as to form the circuit of the second trap when a high-frequency signal in the first frequency band is received and form the circuit of the first trap when a high-frequency signal in the second frequency band is received.

9. A high-frequency receiver apparatus as claimed in claim 8,
wherein the trap switching means performs the switching based on a control voltage that is switched between different levels according to whether to receive a high-frequency signal in the first or second frequency band.

10. A high-frequency receiver apparatus as claimed in claim 9,
wherein the trap switching means is a switching diode that is turned on and off by the control voltage.
